(19) United States
(12) Patent Application Publication
(10) Pub. No.: US 2022/0084316 A1
(43) Pub. Date: Mar. 17, 2022

(54) METHOD AND ELECTRONIC DEVICE FOR RECOGNIZING ABNORMAL SITTING POSTURE, AND STORAGE MEDIUM

(71) Applicant: Shanghai SenseTime Lingang Intelligent Technology Co., Ltd., Shanghai (CN)

(72) Inventors: Fei WANG, Shanghai (CN); Chen QIAN, Shanghai (CN)

(21) Appl. No.: 17/536,840

(22) Filed: Nov. 29, 2021

Related U.S. Application Data
(63) Continuation of application No. PCT/CN2020/136267, filed on Dec. 14, 2020.

(30) Foreign Application Priority Data
Aug. 7, 2020 (CN) 202010790210.0

(51) Int. Cl. G06V 20/59; G06V 40/20; G06V 10/44; G08B 21/02

(52) U.S. Cl. CPC G06V 20/597; G08B 21/02; G06V 10/443; G06V 40/20

(57) ABSTRACT

A method and an electronic device for recognizing an abnormal sitting posture and a storage medium are provided. The method includes: acquiring a present scene image in a cabin; recognizing a present sitting posture of at least one user located within the cabin according to the present scene image; and issuing a warning message in a case where a present sitting posture of a user belongs to an abnormal sitting posture type, the abnormal sitting posture type including a sitting posture type having a safety risk.

### CROSS-REFERENCE TO RELATED APPLICATION

This application is a continuation application of International Patent Application No. PCT/CN2020/136267, filed on Dec. 14, 2020, which claims priority to Chinese Patent Application No. 202010790210.0, filed on Aug. 7, 2020. The disclosures of International Patent Application No. PCT/CN2020/136267 and Chinese Patent Application No. 202010790210.0 are hereby incorporated by reference in their entireties.

### BACKGROUND

With the rapid development of present automotive electronics industry, the convenient, comfortable and safe cabin environment has become the basic demand of users, and therefore, the cabin intelligentization has become an important direction for the development of the present automotive electronics industry.

In related art, cabin intelligentization includes personalized service, safety perception and so on. In the aspect of safety perception, because the sitting posture held by the user during the driving of the vehicle is related to the safety degree of the user, that is, an improper sitting posture may increase the probability of injury of the user when a collision event occurs in the vehicle, thereby reducing the safety degree of the user riding on the vehicle.

### SUMMARY

In view of this, the embodiments of the present disclosure desire to provide a method and electronic device for recognizing an abnormal sitting posture and a storage medium.

The present disclosure relates to the field of deep learning technologies, and in particular, to a method and an electronic device for recognizing an abnormal sitting posture, and a storage medium.

The embodiments of the present disclosure provide a method for recognizing an abnormal sitting posture, which includes that:

a present scene image in a cabin is acquired;

a present sitting posture of at least one user located within the cabin is recognized according to the present scene image; and

a warning message is issued in the case where a present sitting posture of a user belongs to an abnormal sitting posture type, where the abnormal sitting posture type includes a sitting posture type having a safety risk.

The embodiments of the present disclosure an electronic device for recognizing an abnormal sitting posture. Herein the electronic device includes a processor, a memory, and a bus, and the processor is configured to:

acquire a present scene image in a cabin;

recognize a present sitting posture of at least one user located in the cabin according to the present scene image; and

issue a warning message in the case where a present sitting posture of a user belongs to an abnormal sitting posture type, herein the abnormal sitting posture type includes a sitting posture type having a safety risk.

The embodiments of the present disclosure provide a computer-readable storage medium on which a computer program is stored, the computer program performing the operations in a method for recognizing an abnormal sitting posture, and the method includes that:

a present scene image in a cabin is acquired;

a present sitting posture of at least one user located within the cabin is recognized according to the present scene image;

a warning message is issued in the case where a present sitting posture of a user belongs to an abnormal sitting posture type, where the abnormal sitting posture type includes a sitting posture type having a safety risk.

### BRIEF DESCRIPTION OF THE DRAWINGS

In order to more clearly illustrate the technical solutions in the embodiments of the present disclosure, the accompanying drawings, which are incorporated herein and form part of this specification, will be briefly described below, and which illustrate embodiments consistent with the present disclosure and together with the specification serve to illustrate the technical solutions of the present disclosure. It should be understood that the following drawings show only certain embodiments of the present disclosure and should not be regarded as limiting the scope, and that other relevant drawings may be obtained from these drawings without creative effort by those of ordinary skill in the art.

FIG. 1 illustrates a flowchart of a method for recognizing an abnormal sitting posture according to an embodiment of the present disclosure.

FIG. 2 illustrates a schematic diagram of a system architecture in a method for recognizing an abnormal sitting posture applying an embodiment of the present disclosure.

FIG. 3 illustrates a schematic diagram of a present scene image in a method for recognizing an abnormal sitting posture according to an embodiment of the present disclosure.

FIG. 4 illustrates a schematic architectural diagram of an apparatus 400 for recognizing an abnormal sitting posture according to an embodiment of the present disclosure.

FIG. 5 illustrates a schematic diagram of an electronic device 500 according to an embodiment of the present disclosure.

### DETAILED DESCRIPTION

In order to make the objectives, technical solutions and advantages in the embodiments of the present disclosure clearer, the technical solutions in the embodiments of the present disclosure will be clearly and completely described in the following with reference to the accompanying drawings in the embodiments of the present disclosure. It is apparent that the described embodiments are only a part of the embodiments of the present disclosure, but not all of the embodiments. Components in the embodiments of the present disclosure, which are generally described and illustrated in drawings, may be arranged and designed in various different configurations. Accordingly, the following detailed description of embodiments of the present disclosure provided in the accompanying drawings is not intended to limit the claimed scope in the present disclosure, but merely represents selected embodiments of the present disclosure. According to the embodiments of the present disclosure, all other embodiments obtained by those skilled in the art without creative effort fall within the scope claimed by the present disclosure.

In related art, cabin intelligentization may include personalized service, safety perception and so on. In the aspect of safety perception, because the sitting posture held by the user during the driving of the vehicle is related to the safety degree of the user, that is, an improper sitting posture may increase the probability of injury of the user when a collision event occurs in the vehicle, thereby reducing the safety degree of the user riding on the vehicle. And therefore, in order to solve the above problem, the embodiments of the present disclosure provide a method for recognizing an abnormal sitting posture.

In order to facilitate understanding of the embodiments of the present disclosure, a method for recognizing an abnormal sitting posture disclosed in the embodiments of the present disclosure will be firstly described in detail.

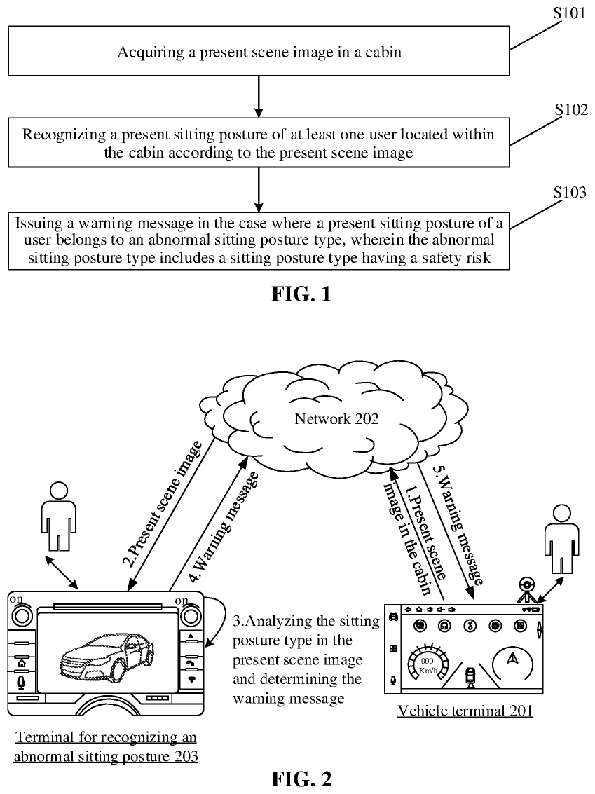

Referring to FIG. 1, there is provided a flowchart of a method for recognizing an abnormal sitting posture according to an embodiment of the present disclosure. The method includes S101 to S103.

In S101, a present scene image in a cabin is acquired.

In S102, a present sitting posture of at least one user located within the cabin is recognized according to the present scene image.

In S103, a warning message is issued in the case where a present sitting posture of a user belongs to an abnormal sitting posture type, the abnormal sitting posture type includes a sitting posture type having a safety risk.

In the above method, by recognizing the acquired present scene image in the cabin, the present sitting posture of at least one user within the cabin is determined, and furthermore, in the case where the present sitting posture of the user belongs to the abnormal sitting posture type, a warning message is issued to remind users who are in an abnormal sitting posture to improve the safety of the user riding on the vehicle.

FIG. 2 illustrates a schematic diagram of a system architecture in a method for recognizing an abnormal sitting posture applying an embodiment of the present disclosure. As illustrated in FIG. 2, the system architecture includes a vehicle terminal 201, a network 202, and a terminal 203 for recognizing an abnormal sitting posture. In order to achieve support of an exemplary application, the vehicle terminal 201 and the terminal 203 for recognizing an abnormal sitting posture may establish a communication connection through the network 202. The vehicle terminal 201 reports a present scene image in the cabin to the terminal 203 for recognizing an abnormal sitting posture through the network 202. The terminal 203 for recognizing an abnormal sitting posture recognizes a present sitting posture of at least one user located in the cabin according to the present scene image in response to the received present scene image. And in the case where the present sitting posture of the user belongs to the abnormal sitting posture type, a warning message is determined. Finally, the terminal 203 for recognizing an abnormal sitting posture uploads the warning message to the network 202, and transmits the warning message to the vehicle terminal 201 through the network 202.

As an example, the vehicle terminal 201 may include an in-vehicle image acquisition device, and the terminal 203 for recognizing an abnormal sitting posture may include an in-vehicle vision processing device having a visual information processing capability or a remote server. The network 202 may be connected in a wired or wireless manner. When the terminal for recognizing an abnormal sitting posture is a in-vehicle vision processing device, the vehicle terminal may communicate with the in-vehicle vision processing device through a wired connection, for example, performing data communication through a bus. When the terminal for recognizing an abnormal sitting posture is a remote server, the vehicle terminal can interact data with the remote server through a wireless network.

Alternatively, in some scenarios, the vehicle terminal 201 may be an in-vehicle vision processing device with an in-vehicle image acquisition module, specifically implemented as an in-vehicle host with a camera. At this time, the method for recognizing an abnormal sitting in the embodiments of the present disclosure may be performed by the vehicle terminal 201, and the system architecture may not include the network 202 and the terminal 203 for recognizing an abnormal sitting posture.

In S101:

Here, an imaging device may be provided at the top of the cabin, and a present scene image in the cabin may be acquired in real time by the imaging device provided in the cabin. The mounting position of the imaging device may be a position where all users in the cabin can be photographed.

In S102:

After the present scene image is acquired, the present scene image may be recognized, and the present sitting posture corresponding to each user in the cabin may be determined. The present sitting posture may be a sitting posture classification of each user.

In a possible implementation, the operation that a present sitting posture of at least one user located within the cabin is recognized according to the present scene image may include that:

key point information of at least one user in the present scene image may be determined according to the present scene image;

a present sitting posture of each user located within the cabin may be determined according to a relative positional relationship between key point information of each user and a set reference object.

Here, the present scene image may be input to a neural network for key point detection to determine key point information of at least one user in the present scene image; and for each user in the cabin, the present sitting posture of the user may be determined according to the relative positional relationship between the key point information of the user and the set reference object.

In a possible implementation, the key point information includes head key point information; the operation that a present sitting posture of each user located within the cabin may be determined according to a relative positional relationship between key point information of each user and a set reference object may include that:

if the head key point information of any user is lower than a set steering wheel lower line, the present sitting posture of the any user being the first abnormal sitting posture where the body of the user leans forward may be determined.

Referring to a method for recognizing an abnormal sitting posture illustrated in FIG. 3, a schematic diagram of a present scene image includes a steering wheel 31, a steering wheel lower line 32, and a driver 33. The steering wheel lower line 32 is a reference line perpendicular to a driving direction at an edge of the steering wheel near the driver side. As can be seen from FIG. 3, the present scene image is divided into two regions by the steering wheel lower line, that is, a first region 34 above the steering wheel lower line and a second region 35 below the steering wheel lower line. When it is detected that the head key point information of the user is lower than the set steering wheel lower line, that is, when it is detected that the head key point information of the user is located in the second region 35, it is determined that the present sitting posture of the user is the first abnormal sitting posture where the user leans forward. When it is detected that the head key point information of the user is higher than the set steering wheel lower line, that is, when it is detected that the head key point information of the user is located in the first region 34, it is determined that the present sitting posture of the user does not belong to the first abnormal sitting posture where the user leans forward. When the head key point information of the user is located at the steering wheel lower line, it is determined that the present sitting posture of the user does not belong to the first abnormal sitting posture where the user leans forward.

In a possible implementation, the key point information includes left shoulder key point information and right shoulder key point information; the operation that a present sitting posture of each user located within the cabin may be determined according to a relative positional relationship between key point information of each user and a set reference object includes that:

if an angle between a line from a left shoulder key point of any user to a right shoulder key point of the any user and a set seat reference surface is greater than the set first angle threshold, the present sitting posture of the any user being the second abnormal sitting posture where the body of the user leans sideways may be determined.

Here, the first angle threshold may be set according to actual needs, for example, the first angle may be 45 degrees; and one side of the user back against the seat (i.e. the vertical surface of the seat) can be set as the seat reference surface. Furthermore, an angle between the detected connection line from the left shoulder key point to the right shoulder key point and the set seat reference surface can be determined, and when the angle is greater than the set first angle threshold, the present sitting posture of the user is determined as the second abnormal sitting posture where the body of the user leans sideways. When the angle is less than or equal to the set first angle threshold, it is determined that the present sitting posture of the user does not belong to the second abnormal sitting posture where the user leans sideways.

In a possible implementation, the key point information includes neck key point information and crotch key point information; the operation that a present sitting posture of each user located within the cabin may be determined according to a relative positional relationship between key point information of each user and a set reference object includes that:

if an angle between a line from a neck key point of any user to a crotch key point of the any user and a set horizontal reference surface is less than a set second angle threshold, a present sitting posture of the any user being a third abnormal sitting posture where the body of the user lies horizontally may be determined.

Here, the set horizontal reference surface may be a horizontal surface of the seat, and the second angle threshold may be set according to actual needs. The angle between the line from the neck key point to the crotch key point and the set horizontal reference surface may be determined. When the angle is less than the set second angle threshold, the present sitting posture of the user is determined as the third abnormal sitting posture where the body of the user lies horizontally. When the angle is greater than or equal to the set second angle threshold, it is determined that the present sitting posture of the user does not belong to the third abnormal sitting posture where the body of the user lies horizontally.

In a specific implementation, a present scene image may also be input into a trained neural network to determine a present sitting posture of each user included in the present scene image.

As an alternative implementation, the operation that a present sitting posture of at least one user located within the cabin may be recognized according to the present scene image may include the following operations.

Operation 1, an intermediate characteristic map corresponding to the present scene image is generated according to the present scene image.

Operation 2, detection frame information of each of at least one user located within the cabin is generated according to the intermediate characteristic map.

Operation 3, a present sitting posture of each user is determined according to the intermediate characteristic map and the detection frame information of each of the at least one user.

In operation 1, a present scene image may be input to a trained neural network, and a backbone network in the neural network performs convolution processing on the present scene image for multiple times to generate an intermediate characteristic map corresponding to the present scene image.

In operation 2, the branch network may be detected using the intermediate characteristic map and the detection frame included in the neural network to generate detection frame information for each of the at least one user located in the cabin.

In an alternative implementation, the operation that detection frame information of each of at least one user located within the cabin may be generated according to the intermediate characteristic map may include the following operations.

In operation A1, at least one first convolution processing is performed on the intermediate characteristic map to generate a channel characteristic map corresponding to the intermediate characteristic map.

In operation A2, center point position information of a detection frame for each user located within the cabin is generated according to a target channel characteristic map representing a position in the channel characteristic map.

Here, at least one first convolution processing may be firstly performed on the intermediate characteristic map to generate a channel characteristic map corresponding to the intermediate characteristic map, and the channel number corresponding to the channel characteristic map may be three channels. The channel characteristic map includes a first channel characteristic map representing the position (the first channel characteristic map is a target channel characteristic map), a second channel characteristic map representing the length information of the detection frame, and a third channel characteristic map representing the width information of the detection frame.

Furthermore, the center point position information of the detection frame of each user included in the cabin may be generated according to the target channel characteristic map representing the position in the channel characteristic map, and the size information (length and width) of the detection frame may be determined according to the second channel characteristic map and the third channel characteristic map in the channel characteristic map.

In the above implementation, the detection frame information (including the center point position information) corresponding to the user may be determined using the characteristic map processing manner, and then the detection frame information is compared with the intermediate characteristic map corresponding to the present scene image to determine the present position information of the user.

As an alternative implementation, the operation that center point position information of a detection frame for each user located within the cabin may be generated according to a target channel characteristic map representing a position in the channel characteristic map may include the following operations.

In operation B1, characteristic value conversion processing is performed on each characteristic value in the target channel characteristic map representing the position by using an activation function to generate the converted target channel characteristic map.

In operation B2, maximum pooling processing is performed on the converted target channel characteristic map according to a preset pooling size and a pooling step, to obtain multiple pooling values and a position index corresponding to each of the multiple pooling values, the position index is used to identify the position of the pooling value in the converted target channel characteristic map.

In operation B3, a target pooling value belonging to a center point of a detection frame of at least one user is determined from multiple pooling values according to the each pooling value and a pooling threshold.

In operation B4, center point position information of a detection frame of each user located within the cabin is generated according to a position index corresponding to the target pooling value.

In the embodiments of the present disclosure, the activation function may be used to perform characteristic value conversion processing on the target characteristic map to generate the converted target channel characteristic map, and each characteristic value in the target channel characteristic map is a value between 0 to 1. The activation function may be a sigmoid function. For the characteristic value of any characteristic point in the converted target channel characteristic map, if the characteristic value tends to 1, the probability that the characteristic point corresponding to the characteristic value belongs to the center point of the detection frame of the user becomes larger.

Then, according to a preset pooling size and a preset pooling step, maximum pooling processing may be performed on the converted target channel characteristic map to obtain a corresponding pooling value at each characteristic position in the target channel characteristic map and a position index corresponding to each pooling value. The position index can be used to identify the position of the pooling value in the converted target channel characteristic map. Then, the same position index in the position index corresponding to each characteristic position may be combined to obtain multiple pooling values corresponding to the target channel characteristic map and a position index corresponding to each of the multiple pooling values. The preset pooling size and step size may be set according to actual needs, for example, the preset pooling size may be 3×3, and the preset pooling step may be 1.

Furthermore, the pooling threshold may be set, the obtained multiple pooling values are screened to obtain at least one target pooling value greater than the pooling threshold among the multiple pooling values, and the center point position information of the detection frame for each user included in the cabin is generated according to the position index corresponding to the target pooling value. For example, a multi-frame sample image, acquired by the imaging device, corresponding to the present scene image may be acquired, and a pooling threshold may be generated according to the acquired multi-frame sample image by using an adaptive algorithm.

Exemplarily, a maximum pooling processing of 3×3 with a step of 1 can be performed on the target channel characteristic map. in pooling, the maximum response values (i.e., pooling value) of 3×3 characteristic points and the position indexes of the maximum response values on the target channel characteristic map are determined for each 3×3 characteristic points in the target channel characteristic map. At this time, the number of maximum response values is related to the size of the target channel characteristic map. For example, if the size of the target channel characteristic map is 80×60×3, a total of 80×60 maximum response values are obtained after maximum pooling processing is performed on the target channel characteristic map; and for each maximum response value, there may be at least one other maximum response value that is identical to its position index.

The maximum response values with the same position index are then combined to obtain the M maximum response values and the position index corresponding to each of the M maximum response values.

Each of the M maximum response values is then compared to a pooling threshold. When a maximum response value is greater than the pool threshold, the maximum response value is determined as the target pooling value. The position index corresponding to the target pooling value is the center point position information of the detection frame of the user.

Here, the target channel characteristic map before conversion may be directly subjected to maximum pooling processing to obtain the center point position information of the detection frame of each user.

Exemplarily, after obtaining the center point position information of the detection frame of the user, the second characteristic value at the characteristic position matching the center point position information may be selected from the second channel characteristic map according to the center point position information, the selected second characteristic value may be determined as the length corresponding to the detection frame of the user; the third characteristic value at the characteristic position matching the center point position information may be selected from the third channel characteristic map, and the selected third characteristic value may be determined as the width corresponding to the detection frame of the user, then the size information of the detection frame of the user is obtained.

In the above implementation, by performing maximum pooling processing on the target channel characteristic map, the target pooling value belonging to the user center point can be more accurately determined from multiple pooling values, and furthermore, the center point position information of the detection frame of each user can be more accurately determined.

In operation 3, the present sitting posture of each user may be determined according to the intermediate characteristic map, the detection frame information of each of the at least one user, and the posture classification branch network of the trained neural network.

In some embodiments, the operation that a present sitting posture of each user is determined according to the intermediate characteristic map and detection frame information of each of the at least one user includes the following operations.

In operation C1, at least one second convolution processing is performed on the intermediate characteristic map to generate a classification characteristic map, corresponding to the intermediate characteristic map, of N channels, the number of channels N of the classification characteristic map is identical to the number of sitting posture classifications, each channel characteristic map in the classification characteristic map of the N channels corresponds to one sitting posture classification, and N is a positive integer greater than 1;

In operation C2, for each user, N characteristic values at characteristic positions matching the center point position information is extracted from the classification characteristic map according to the center point position information indicated by the detection frame information of the user; a maximum characteristic value is selected from the N characteristic values; and a sitting posture classification of the channel characteristic map corresponding to the maximum characteristic value in the classification characteristic map is determined as the present sitting posture of the user.

Here, the intermediate characteristic map may be subjected to at least one second convolution processing to generate a classification characteristic map corresponding to the intermediate characteristic map. The number of channels in the classification characteristic map is N, the value of N is consistent with the number of sitting posture classifications, and each channel characteristic map in the classification characteristic map of the N channel corresponds to one sitting posture classification. For example, if the classifications of the sitting posture include normal sitting posture, body leaning forward, and body leaning back, then the value of N is 3; if the classifications of sitting posture include normal sitting posture, body leaning forward, body leaning back, and body lying horizontally, then the value of N is 4. Here, the classifications of sitting posture may be set according to actual needs, and only an exemplary description is given herein.

Furthermore, for each user, the N characteristic values at the characteristic positions matching the center point position information may be extracted from the classification characteristic map according to the center point position information indicated by detection frame information of the user; the maximum characteristic value may be selected from the N characteristic values; and the sitting posture classification of the channel characteristic map corresponding to the maximum characteristic value in the classification characteristic map may be determined as the present sitting posture of the user.

For example, for the user A, the classification characteristic map is a characteristic map of the three channels, the sitting posture classification corresponding to the first channel characteristic map in the classification characteristic map may be a normal sitting posture, the sitting posture classification corresponding to the second channel characteristic map may be a body leaning forward, and the sitting posture classification corresponding to the third channel characteristic map may be a body leaning sideways; and three characteristic values, that is, 0.8, 0.5, and 0.2, are extracted from the classification characteristic map; and then the sitting posture classification (normal sitting posture) of the channel characteristic map (the first channel characteristic map in the classification characteristic map) corresponding to 0.8 in the classification characteristic map is determined as the present sitting posture of the user A.

Here, by performing at least one second convolution processing on the intermediate characteristic map, the classification characteristic map is generated, and by combining the generated center point position information of each user, the present sitting posture of each user can be more accurately determined.

In some embodiments, the present sitting posture of each user is determined by a training-based neural network. The neural network may be trained by the following operations.

In operation D1, a scene image sample is acquired, the scene image sample corresponds to annotated data.

In operation D2, a sample characteristic map corresponding to the scene image sample is generated according to the backbone network of the neural network and the scene image sample.

In operation D3, multiple types of prediction data corresponding to a scene image sample is generated according to multiple branch networks of a neural network and a sample characteristic map, each branch network corresponds to one type of prediction data.

In operation D4, the neural network is trained according to multiple types of prediction data and annotated data corresponding to the scene image sample.

In the above manner, multiple branch networks are provided to process the sample characteristic map to generate multiple types of prediction data corresponding to the scene image sample, and when the neural network is trained by the generated multiple types of prediction data, the accuracy of the trained neural network may be improved.

Here, the annotated data may include annotated key point position information, annotated detection frame information, and annotated sitting posture classification.

The scene image sample may be input into a neural network to be trained, and a backbone network in the neural network to be trained performs at least one convolution processing on the scene image sample to generate a sample characteristic map corresponding to the scene image sample.

The sample characteristic map is then input to multiple branch networks in the neural network to be trained, respectively, to generate multiple types of prediction data corresponding to the scene image sample, and each branch network corresponds to one type of prediction data.

The prediction data may include prediction detection frame information, prediction key position point information, and prediction sitting posture classification.

When the prediction data includes the prediction detection frame information, the branch network of the neural network includes branch network of the detection frame detection, the sample characteristic map is input to the branch network of the detection frame detection in the neural network to generate the prediction detection frame information of at least one user included in the scene image sample.

When the prediction data includes the prediction key point information, the branch network of the neural network includes the branch network of the key point detection, and the sample characteristic map is input to the branch network of the key point detection in the neural network to generate multiple prediction key point information of each user included in the scene image sample.

When the prediction data includes the prediction detection frame information and the prediction sitting posture classification, the branch network of the neural network includes the branch network of the detection frame detection and the branch network of posture classification, the sample characteristic map is input to the branch network of the key point detection in the neural network to obtain the classification characteristic map, and the prediction sitting posture classification of each user included in the scene image sample is generated according to the prediction detection frame information of at least one user and the classification characteristic map.

In the above implementation, multiple branch networks are provided to process the sample characteristic map to obtain multiple types of prediction data, and the neural network is trained by the multiple types of prediction data, so that the accuracy of the trained neural network is higher.

When multiple types of prediction data include prediction detection frame information, prediction key position point information, and prediction sitting posture classification, a first loss value may be generated according to the prediction detection frame information and the annotated detection frame information; a second loss value is generated according to the prediction key position point information and the annotated key position point information; a third loss value is generated according to the prediction sitting posture classification and the annotated sitting posture classification, and the neural network is trained according to the first loss value, the second loss value and the third loss value to obtain the trained neural network.

In operation S103:

After obtaining the present sitting posture of each user in the present scene image, whether the present sitting posture of the user belongs to an abnormal sitting posture may be determined according to the present sitting posture of each user, and the abnormal sitting posture type refers to a sitting posture type having a safety risk. When it is determined that the present sitting posture of the user belongs to the abnormal sitting posture, a warning message is issued.

In an alternative embodiment, the abnormal sitting posture type may include at least one of a first abnormal sitting posture where the body of the user leans forward, a second abnormal sitting posture where the body of the user leans sideways, and a third abnormal sitting posture where the body of the user lies horizontally. The abnormal sitting posture type may also include other sitting posture where there is a safety risk, which is only exemplarily described herein.

Exemplarily, when the present sitting posture of the user is the normal sitting posture, it is determined that the user does not belong to the abnormal sitting posture; when the present sitting posture of the user is body leaning forward, it is determined that the user belongs to an abnormal sitting posture.

In the above implementation, by defining multiple abnormal sitting postures, the abnormal sitting posture type is rich, so that the multiple abnormal sitting postures can be covered more comprehensively, and the safety of the user riding on the vehicle is ensured.

Here, when it is determined that the present sitting posture of the user belongs to the abnormal sitting posture type, a warning message may be generated according to the abnormal sitting posture type to which the present sitting posture of the user belongs, and the warning message may be played in the form of voice. For example, when the present sitting posture of user A is body leaning forward, the generated warning message may be “danger, body leaning forward, please adjust the sitting posture”.

In specific implementation, each position in the cabin may also be identified. For example, the identification of each position in the cabin may be a co-pilot position, a rear-left position, a rear-right position, or the like, and the position identification corresponding to each user is determined according to the present scene image, and when it is determined that the present sitting posture of the user belongs to the abnormal sitting posture type, the warning information may be generated according to the abnormal sitting posture type to which the present sitting posture of the user belongs and the sitting posture identification. For example, when the present sitting posture of the user A is the body leaning forward, and the position identification corresponding to the user A is the co-pilot position, the generated warning message may be “the body leaning forward of the passenger in the co-pilot position, please adjust the sitting posture”.

Here, when it is determined that the present sitting posture of the user belongs to the abnormal sitting posture type, a warning message may be generated according to the abnormal sitting posture type to which the present sitting posture of the user belongs, so as to warn the user and reduce the probability that the user is in danger.

It will be understood by those skilled in the art that, in the above method of a specific implementation, the order in which the operations are written does not imply a strict order of execution and constitute any limitation on the implementation process, and that the specific order in which the operations are performed should be determined by their functions and possible internal logic.

According to the same concept, the embodiments of the present disclosure further provide an apparatus 400 for recognizing an abnormal sitting posture. Referring to FIG. 4, there is provided a schematic architectural diagram of an apparatus for recognizing an abnormal sitting posture according to an embodiment of the present disclosure. The apparatus includes an acquisition module 401, a recognition module 402, and a determination module 403.

The acquisition module 401 is configured to acquire a present scene image in a cabin.

The recognition module 402 is configured to recognize a present sitting posture of at least one user located in the cabin according to the present scene image.

The determination module 403 is configured to issue a warning message in the case where a present sitting posture of a user belongs to an abnormal sitting posture type, the abnormal sitting posture type refers to a sitting posture type having a safety risk.

In a possible implementation, the abnormal sitting posture type includes at least one of a first abnormal sitting posture where the body of the user leans forward, a second abnormal sitting posture where the body of the user leans sideways, or a third abnormal sitting posture where the body of the user lies horizontally.

In a possible implementation, the recognition module 402, when recognizing the present sitting posture of at least one user located in the cabin according to the present scene image, is configured to:

determine key point information of at least one user in the present scene image according to the present scene image; and

determine a present sitting posture of each user located within the cabin according to a relative positional relationship between key point information of each user and a set reference object.

In a possible implementation, the key point information includes head key point information. The recognition module 402, when determining the present sitting posture of each user located in the cabin according to the relative positional relationship between the key point information of each user and the set reference object, is configured to:

when the head key point information of any user is lower than a set steering wheel lower line, determine that the present sitting posture of the any user is the first abnormal sitting posture where the body of the user leans forward.

In a possible implementation, the key point information includes left shoulder key point information and right shoulder key point information. The recognition module 402, when determining the present sitting posture of each user located in the cabin according to the relative positional relationship between the key point information of each user and the set reference object, is configured to:

when an angle between a line from a left shoulder key point of any user to a right shoulder key point of the any user and a set seat reference surface is greater than the set first angle threshold, determine that the present sitting posture of the any user is the second abnormal sitting posture where the body of the user leans sideways.

In a possible implementation, the key point information includes neck key point information and crotch key point information. The recognition module 402, when determining the present sitting posture of each user located within the cabin according to the relative positional relationship between the key point information of each user and the set reference object, is configured to:

when an angle between a line from a neck key point of any user to a crotch key point of the any user and a set horizontal reference surface is less than a set second angle threshold, determine that a present sitting posture of the any user is a third abnormal sitting posture where the body of the user lies horizontally.

In a possible implementation, the recognition module 402, when recognizing the present sitting posture of at least one user located within the cabin according to the present scene image, is configured to:

generate an intermediate characteristic map corresponding to the present scene image according to the present scene image;

generate detection frame information of each of at least one user located within the cabin according to the intermediate characteristic map; and

determine a present sitting posture of each user according to the intermediate characteristic map and the detection frame information of each of the at least one user.

In a possible implementation, the recognition module 402, when generating detection frame information for each of at least one user located within the cabin according to the intermediate characteristic map, is configured to:

perform at least one first convolution processing on the intermediate characteristic map to generate a channel characteristic map corresponding to the intermediate characteristic map; and

generate center point position information of a detection frame for each user located within the cabin according to a target channel characteristic map representing a position in the channel characteristic map.

In a possible implementation, the recognition module 402, when generating the center point position information of the detection frame of each user located within the cabin according to the target channel characteristic map representing the position in the channel characteristic map, is configured to:

perform, by using an activation function, characteristic value conversion processing on each characteristic value in the target channel characteristic map representing the position, to generate the converted target channel characteristic map;

performing maximum pooling processing on the converted target channel characteristic map according to a preset pooling size and a pooling step, to obtain multiple pooling values and a position index corresponding to each of the multiple pooling values, the position index is used to identify the position of the pooling value in the converted target channel characteristic map;

determine a target pooling value belonging to a center point of a detection frame of at least one user from multiple pooling values according to the each pooling value and a pooling threshold; and

generate center point position information of a detection frame of each user located within the cabin according to a position index corresponding to the target pooling value.

In a possible implementation, the recognition module 402, when determining the present sitting posture of each user according to the intermediate characteristic map and the detection frame information of each of the at least one user, is configured to:

perform at least one second convolution processing on the intermediate characteristic map to generate a classification characteristic map, corresponding to the intermediate characteristic map, of N channels, the number of channels N of the classification characteristic map coincides with the number of sitting posture classifications, each channel characteristic map in the classification characteristic map of the N channels corresponds to one sitting posture classification, and N is a positive integer greater than 1;

extract, for each user, N characteristic values at characteristic positions matching the center point position information from the classification characteristic map according to the center point position information indicated by the detection frame information of the user; select a maximum characteristic value from the N characteristic values, and determine a sitting posture classification of the channel characteristic map corresponding to the maximum characteristic value in the classification characteristic map as the present sitting posture of the user.

In some embodiments, the functions or templates included in the apparatus provided in the embodiments of the present disclosure may be used to perform the methods described in the above method embodiments, and specific implementations thereof may be described with reference to the above method embodiments. For brevity, details are not described herein.

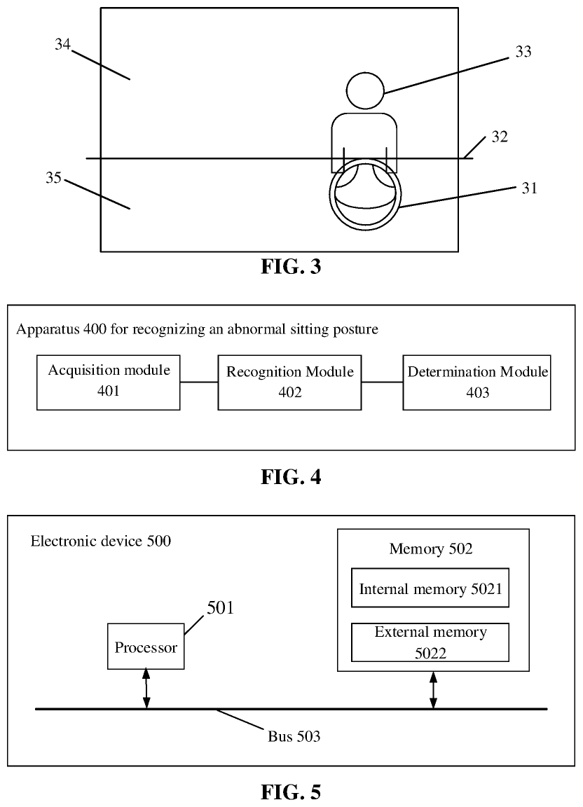

According to the same technical concept, the embodiments of the present disclosure further provide an electronic device 500. Referring to FIG. 5, there is provided a schematic diagram of an electronic device 500 according to an embodiment of the present disclosure. The electronic device includes a processor 501, a memory 502, and a bus 503. The memory 502 is configured to store execution instructions, including an internal memory 5021 and an external memory 5022. Here, an internal memory 5021, also referred to as an inner memory, is used to temporarily store operation data in the processor 501 and data exchanged with an external memory 5022 such as a hard disk. The processor 501 exchanges data with the external memory 5022 through the internal memory 5021, and when the electronic device 500 is running, the processor 501 communicates with the memory 502 through the bus 503 so that the processor 501 executes the following instructions:

acquiring a present scene image in a cabin;

recognizing a present sitting posture of at least one user located in the cabin according to the present scene image; and

issuing a warning message in the case where a present sitting posture of a user belongs to an abnormal sitting posture type, the abnormal sitting posture type refers to a sitting posture type having a safety risk.

In addition, the embodiments of the present disclosure further provide a computer-readable storage medium on which a computer program is stored, the computer program performs the steps in the method for recognizing an abnormal sitting posture in the above method embodiments when executed by a processor.

The computer program product of the method for recognizing an abnormal sitting posture provided by the embodiments of the present disclosure is used to store computer readable code, and when the computer readable code runs in an electronic device, a processor of the electronic device implements the method for recognizing an abnormal sitting posture provided by any one of the above embodiments.

Those skilled in the art will clearly understand that for the convenience and brevity of the description, the detailed working process of the system and apparatus described above may be referred to the corresponding process in the above method embodiments, and details are not described herein again. In the several embodiments provided by the present disclosure, it should be understood that the disclosed systems, apparatus, and methods may be implemented in other ways. The apparatus embodiments described above are merely illustrative. For example, the division of the units is merely a logical function division, and may be implemented in another manner. For another example, multiple units or components may be combined or integrated into another system, or some features may be ignored or not performed. Alternatively, the displayed or discussed coupling or direct coupling or communication connection to one another may be via some communication interface, indirect coupling or communication connection to a device or unit, may be in electrical, mechanical or other form.

The units described as separate components may or may not be physically separate, and the components displayed as units may or may not be physical units, i.e. may be located in one place, or may be distributed over multiple network units. Some or all of the units may be selected according to actual needs to achieve the objectives of the solutions in this embodiment.

In addition, each functional unit in various embodiments of the present disclosure may be integrated in one processing unit, or each unit may exist separately physically, or two or more units may be integrated in one unit.

The functions may be stored in a processor executable non-volatile computer readable storage medium if implemented in the form of a software functional unit and sold or used as an independent product. According to such an understanding, the technical solutions of the present disclosure essentially, or part of a contribution to the prior art, or part of the technical solutions may be embodied in the form of a software product stored in a storage medium, including several instructions for causing a computer device (which may be a personal computer, a server, a network device, or the like) to perform all or part of the steps of the methods described in the various embodiments of the present disclosure. The above storage medium includes a USB flash disk, a removable hard disk, a read-only memory (ROM), a random access memory (RAM), a magnetic disk, an optical disk, or any other medium that can store program code.

The above is merely a specific implementation of the present disclosure, but the protection scope of the present disclosure is not limited thereto. Any change or replacement readily conceived of by a person skilled in the art within the technical scope disclosed by the present disclosure shall fall within the protection scope of the present disclosure. Therefore, the protection scope of the present disclosure shall be subject to the protection scope of the claims.

### INDUSTRIAL PRACTICALITY

The present disclosure provides a method and an apparatus for recognizing an abnormal sitting posture, an electronic device, a storage medium and a program. The method includes: acquiring a present scene image in a cabin; recognizing a present sitting posture of at least one user located within the cabin according to the present scene image; and issuing a warning message in the case where a present sitting posture of a user belongs to an abnormal sitting posture type, where the abnormal sitting posture type includes a sitting posture type having a safety risk.

1. A method for recognizing an abnormal sitting posture, comprising:
acquiring a present scene image in a cabin;
recognizing a present sitting posture of at least one user located within the cabin according to the present scene image; and
issuing a warning message in a case where a present sitting posture of a user belongs to an abnormal sitting posture type, wherein the abnormal sitting posture type comprises a sitting posture type having a safety risk.

2. The method according to claim 1, wherein the abnormal sitting posture type comprises at least one of:
a first abnormal sitting posture where a body of the user leans forward, a second abnormal sitting posture where the body of the user leans sideways, or a third abnormal sitting posture where the body of the user lies horizontally.

3. The method according to claim 2, wherein recognizing the present sitting posture of the at least one user located within the cabin according to the present scene image comprises:
determining key point information of the at least one user in the present scene image according to the present scene image; and
determining a present sitting posture of each user located within the cabin according to a relative positional relationship between key point information of each user and a set reference object.

4. The method according to claim 3, wherein the key point information comprises head key point information and the determining the present sitting posture of the each user located within the cabin according to the relative positional relationship between the key point information of the each user and the set reference object comprises:
in case that head key point information of any user is lower than a set steering wheel lower line, determining that a present sitting posture of the any user is the first abnormal sitting posture where the body of the user leans forward.

5. The method according to claim 3, wherein the key point information comprises left shoulder key point information and right shoulder key point information, and the determining the present sitting posture of the each user located within the cabin according to the relative positional relationship between the key point information of the each user and the set reference object comprises:
in case that an angle between a line from a left shoulder key point of any user to a right shoulder key point of the any user and a set seat reference surface is greater than a set first angle threshold, determining that a present sitting posture of the any user is the second abnormal sitting posture where the body of the user leans sideways.

6. The method according to claim 3, wherein the key point information comprises neck key point information and crotch key point information, and the determining the present sitting posture of the each user located within the cabin according to the relative positional relationship between the key point information of the each user and the set reference object comprises:
in case that an angle between a line from a neck key point of any user to a crotch key point of the any user and a set horizontal reference surface is less than a set second angle threshold, determining that a present sitting posture of the any user is the third abnormal sitting posture where the body of the user lies horizontally.

7. The method according to claim 1, wherein the recognizing the present sitting posture of the at least one user located within the cabin according to the present scene image comprises:
generating an intermediate characteristic map corresponding to the present scene image according to the present scene image;
generating detection frame information of each of the at least one user located within the cabin according to the intermediate characteristic map; and
determining a present sitting posture of each user according to the intermediate characteristic map and the detection frame information of each of the at least one user.

8. The method according to claim 7, wherein the generating the detection frame information of each of the at least one user located within the cabin according to the intermediate characteristic map comprises:
performing at least one first convolution processing on the intermediate characteristic map to generate a channel characteristic map corresponding to the intermediate characteristic map; and
generating center point position information of a detection frame for each user located within the cabin according to a target channel characteristic map representing a position in the channel characteristic map.

9. The method according to claim 8, wherein the generating the center point position information of the detection frame for the each user located within the cabin according to the target channel characteristic map representing the position in the channel characteristic map, comprises:
performing characteristic value conversion processing on each characteristic value in the target channel characteristic map representing the position by using an activation function to generate a converted target channel characteristic map;
performing maximum pooling processing on the converted target channel characteristic map according to a preset pooling size and a pooling step, to obtain a plurality of pooling values and a position index corresponding to each of the plurality of pooling values, wherein the position index is used to recognize a position of the pooling value in the converted target channel characteristic map;
determining a target pooling value belonging to a center point of the detection frame of the at least one user from the plurality of pooling values according to the each pooling value and a pooling threshold; and
generating the center point position information of the detection frame of the each user located within the cabin according to a position index corresponding to the target pooling value.

10. The method according to claim 7, wherein the determining the present sitting posture of the each user according to the intermediate characteristic map and the detection frame information of each of the at least one user comprises:
performing at least one second convolution processing on the intermediate characteristic map to generate a classification characteristic map, corresponding to the intermediate characteristic map, of N channels, wherein a number of channels N of the classification characteristic map is identical to a number of sitting posture classifications, each channel characteristic map in the classification characteristic map of the N channels corresponds to one sitting posture classification, and N is a positive integer greater than 1;
extracting, for each user, N characteristic values at characteristic positions matching center point position information from the classification characteristic map according to the center point position information indicated by the detection frame information of the user; selecting a maximum characteristic value from the N characteristic values; and determining a sitting posture classification of a channel characteristic map corresponding to the maximum characteristic value in the classification characteristic map as the present sitting posture of the user.

11. An electronic device for recognizing an abnormal sitting posture, the electronic device comprising a processor, a memory, and a bus, wherein the processor is configured to:
acquire a present scene image in a cabin;
recognize a present sitting posture of at least one user located within the cabin according to the present scene image; and
issue a warning message in a case where a present sitting posture of a user belongs to an abnormal sitting posture type, wherein the abnormal sitting posture type comprises a sitting posture type having a safety risk.

12. The electronic device according to claim 11, wherein the abnormal sitting posture type comprises at least one of:
a first abnormal sitting posture where a body of the user leans forward, a second abnormal sitting posture where the body of the user leans sideways, or a third abnormal sitting posture where the body of the user lies horizontally.

13. The electronic device according to claim 12, wherein the processor is configured to:
determine key point information of the at least one user in the present scene image according to the present scene image; and
determine a present sitting posture of each user located within the cabin according to a relative positional relationship between key point information of each user and a set reference object.

14. The electronic device according to claim 13, wherein the key point information comprises head key point information and the processor is further configured to:
in case that head key point information of any user is lower than a set steering wheel lower line, determine that a present sitting posture of the any user is the first abnormal sitting posture where the body of the user leans forward.

15. The electronic device according to claim 13, wherein the key point information comprises left shoulder key point information and right shoulder key point information, and the processor is further configured to:
in case that an angle between a line from a left shoulder key point of any user to a right shoulder key point of the any user and a set seat reference surface is greater than a set first angle threshold, determine that a present sitting posture of the any user is the second abnormal sitting posture where the body of the user leans sideways.

16. The electronic device according to claim 13, wherein the key point information comprises neck key point information and crotch key point information, and the processor is further configured to:
in case that an angle between a line from a neck key point of any user to a crotch key point of the any user and a set horizontal reference surface is less than a set second angle threshold, determine that a present sitting posture of the any user is the third abnormal sitting posture where the body of the user lies horizontally.

17. The electronic device according to claim 11, wherein the processor is further configured to:
generate an intermediate characteristic map corresponding to the present scene image according to the present scene image;
generate detection frame information of each of the at least one user located within the cabin according to the intermediate characteristic map; and
determine a present sitting posture of each user according to the intermediate characteristic map and the detection frame information of each of the at least one user.

18. The electronic device according to claim 17, wherein the processor is further configured to:
perform at least one first convolution processing on the intermediate characteristic map to generate a channel characteristic map corresponding to the intermediate characteristic map; and
generate center point position information of a detection frame for each user located within the cabin according to a target channel characteristic map representing a position in the channel characteristic map.

19. The electronic device according to claim 18, wherein the processor is further configured to:
perform characteristic value conversion processing on each characteristic value in the target channel characteristic map representing the position by using an activation function to generate a converted target channel characteristic map;
perform maximum pooling processing on the converted target channel characteristic map according to a preset pooling size and a pooling step, to obtain a plurality of pooling values and a position index corresponding to each of the plurality of pooling values, wherein the position index is used to recognize a position of the pooling value in the converted target channel characteristic map;
determine a target pooling value belonging to a center point of the detection frame of the at least one user from the plurality of pooling values according to the each pooling value and a pooling threshold; and
generate the center point position information of the detection frame of the each user located within the cabin according to a position index corresponding to the target pooling value.

20. A non-transitory computer-readable storage medium on which a computer program is stored, the computer program performing steps in a method for recognizing an abnormal sitting posture, wherein the method comprises:
acquiring a present scene image in a cabin;
recognizing a present sitting posture of at least one user located within the cabin according to the present scene image; and
issuing a warning message in a case where a present sitting posture of a user belongs to an abnormal sitting posture type, wherein the abnormal sitting posture type comprises a sitting posture type having a safety risk.
